(19) United States
(12) Patent Application Publication
(10) Pub. No.: US 2020/0063265 A1
(43) Pub. Date: Feb. 27, 2020

(54) ARTICLE AND METHOD FOR ITS MANUFACTURE

(71) Applicant: SOLVAY SPECIALTY POLYMERS ITALY S.P.A., Bollate (IT)

(72) Inventors: Stefano MAURI, Giussano (IT); Marco APOSTOLO, Senago (IT); Marco AVATANEO, Milano (IT); Pasqua COLAIANNA, Milano (IT)

(21) Appl. No.: 16/607,099

(22) PCT Filed: Apr. 19, 2018
(86) PCT No.: PCT/EP2018/060008

§ 371 Date: Oct. 21, 2019

Related U.S. Application Data
(60) Provisional application No. 62/488,177, filed on Apr. 21, 2017.

(30) Foreign Application Priority Data
Oct. 31, 2017 (EP) 17199387.6

(51) Int. Cl. C23C 18/30; C23C 18/20; C23C 28/04; C25D 9/08; C09D 127/12; C09D 127/18

(52) U.S. Cl. CPC C23C 18/30; C23C 18/2086; C09D 127/18; C25D 9/08; C09D 127/12; C23C 28/04

(57) ABSTRACT

The present invention relates to a multi-layered article made from a perfluoropolymer and to a method for its manufacturing, the multi-layered article being made of a composition (C) comprising at least one melt-processable fully fluorinated polymer (FMP), said article having at least one surface (S) comprising:—at least one molecule grafted onto said surface (S), said molecule comprising at least one nitrogen atom and at least one carbon atom, and—at least one layer (LI) adhered to said surface (S) comprising at least one metal compound (M).

### CROSS-REFERENCE TO RELATED APPLICATIONS

This application claims priority to U.S. provisional application No. 62/488,177 filed on Apr. 21, 2017 and to an European application No. 17199387.6 filed on Oct. 31, 2017, the whole content of each of these applications being incorporated herein by reference for all purposes.

### TECHNICAL FIELD

The present invention relates to a multi-layered article made from a perfluoropolymer and to a method for its manufacturing.

### BACKGROUND ART

Partially fluorinated polymers are known to be relatively chemically inert, thermally stable polymers, owing primarily to the strength of the carbon-fluorine bonds present in the molecule. Because of their properties, the partially fluorinated polymers are desirable in many applications which require high performances, such as withstanding to high temperatures.

In addition, as a great number of applications in the field of oil and gas, electronics, automotive, and aerospace require the partially fluorinated polymers to have electrical and thermal conductivity or to provide a barrier to gases and liquids, it was proposed in the art to adhesively bond metals to partially fluorinated polymers.

U.S. Pat. No. 5,696,207 (GEO-CENTERS, INC.; THE UNITED STATES OF AMERICA AS REPRESENTED BY THE SECRETARY OF THE NAVY) discloses that fluoropolymeric substrates can be prepared by self-assembly of a chemisorbed layer of a metal ion-chelating organosiloxane onto a fluoropolymer surface after radio-frequency glow discharge plasma surface hydroxylation. According to this process, a fluoropolymer having a surface with hydroxyl groups is reacted with a ligand-bearing coupling agent, such as organosilanes, organotitanate, organozirconate and the like, and then metallized by electroless metal deposition by methods well-known in the art.

In the field of semi-crystalline polymers, WO 2014/154733 (SOLVAY SPECIALTY POLYMERS ITALY S.P.A.) discloses a multilayer mirror assembly made of ethylene-chloro-trifluoro-ethylene (ECTFE), a semi-crystalline partially fluorinated polymer, treated by a radio-frequency plasma discharge process, and then coated with metallic nickel by electroless plating. More recently, WO 2016/079230 (SOLVAY SPECIALTY POLYMERS ITALY S.P.A.) discloses a multi-layered elastomer article made of an elastomeric composition comprising at least one elastomer and having at least one surface comprising nitrogen-containing groups and at least one layer adhered to said surface comprising at least one metal compound.

With the aim of modifying the surface properties of partially and fully fluorinated polymers, U.S. Pat. No. 4,548,867 (SHIN-ETSU CHEMICAL CO., LTD.) discloses a shaped article obtained by subjecting the surface of the article to exposure to low temperature plasma generated in a low pressure atmosphere, of about 10 Torr or below (corresponding to about 1.3×10⁻² atm) of a nitrogen-containing gaseous organic compound such as amines, imides and amides. Actually, this document does not provide any description about the possibility of forming a metal layer adhered to the surface of the article thus modified. In addition, the Applicant noted that the process disclosed in this document is performed under reduced pressure and hence requires expensive apparatus and to properly control the process conditions in order to reach the proper conditions for the reaction to take place.

### SUMMARY OF INVENTION

The Applicant noted that to date, no process has been described in the art to provide a metal layer adhered onto a surface of an article made from melt-processable perfluoropolymers.

More in particular, the Applicant found that the method used in the above mentioned patent applications in the name of Solvay Specialty Polymers Italy S.p.A., namely WO 2014/154733 and WO 2016/079230, do not work when the surface layer is made of a composition comprising a fully fluorinated polymer.

Without being bound by any theory, the Applicant is well aware that articles made from perfluoropolymers are characterized by a lower surface energy compared to articles made from partially fluorinated polymers, which makes more difficult forming a layer adhered thereto.

Thus, the Applicant faced the problem to provide an article made from a composition comprising a fully fluorinated polymer (also referred to as “perfluoropolymer”), said article having at least one surface adhered to a layer comprising metal compound(s).

Surprisingly, the Applicant found that the above problem can be solved by treating at least one surface of an article made from a composition comprising a melt-processable fully fluorinated polymer with at least one gaseous compound comprising at least one nitrogen atom and at least one carbon atom, followed by deposition of a composition comprising at least one metal compound.

Thus, in a first aspect, the present invention relates to a multi-layered article made of a composition [composition (C)] comprising at least one melt-processable fully fluorinated polymer [polymer F_{MP})], said article having at least one surface [surface (S)] comprising:
at least one molecule grafted onto said surface (S), said molecule comprising at least one nitrogen atom and at least one carbon atom, and
at least one layer [layer (L1)] adhered to said surface (S) comprising at least one metal compound [compound (M)].

In a second aspect, the present invention relates to a method comprising the following steps:

(i) providing an article made from a composition [composition (C)] comprising at least one melt-processable fully fluorinated polymer [polymer F_{MP})], said article having at least one surface [surface (S-1)];

(ii) contacting said surface (S-1) with a gaseous compound [compound (G)] comprising at least one nitrogen atom and at least one carbon atom, to provide an article having at least one surface [surface (S-2)];

(iii) contacting said at least one surface (S-2) with a first composition [composition (C1)] comprising at least one metallization catalyst, so as to provide an article having at least one surface [surface (S-3)] containing at least one nitrogen atom bonded to said at least one metallization catalyst; and

(iv) contacting said at least one surface (S-3) with a second composition [composition (C2)] containing at least one metal compound [compound (M1)], so as to provide a multi-layered article having at least one surface [surface (S)] comprising nitrogen-containing groups and at least one layer (L1) adhered to said surface (S) comprising at least one metal compound [compound (M)],

wherein said step (ii) is performed at atmospheric pressure.

Optionally, the above method comprises after step (iv), step (v) of applying a third composition [composition (C3)] containing at least one metal compound [compound (M2)] onto said surface (S).

### DESCRIPTION OF EMBODIMENTS

Preferably, said multi-layered article is in the form of a film or a shaped article.

The thickness of said film is not particularly limited. For example, said film can have a thickness of from 3 μm to 10 mm, more preferably from 100 μm to 8 mm.

For the purpose of the present description and of the following claims:
the use of parentheses around symbols or numbers identifying the formulae, for example in expressions like “composition (C)”, etc., has the mere purpose of better distinguishing the symbol or number from the rest of the text and, hence, said parenthesis can also be omitted;
the expressions “fully fluorinated polymer” and “perfluoropolymer” are used as synonyms and are intended to indicate a polymer consisting essentially of recurring units derived from at least one perfluorinated monomer;
the expression “consisting essentially of” is intended to indicate that minor amounts of end chains, defects, irregularities, monomer rearrangements and monomers comprising hydrogen atoms are tolerated in the perfluoropolymer, provided that their amount is below 5 moles % based on the total moles of the final perfluoropolymer, more preferably below 2 moles %;
the expression “at least one perfluorinated monomer” is intended to indicate that the perfluoropolymer contains recurring units derived from one or more perfluorinated monomers;
the expression “melt-processable” is intended to indicate polymer that can be processed (i.e. fabricated) into shaped articles (such as films, fibers, tubes, fittings, wire coatings and the like) at a temperature higher than their glass transition temperature (T_{g}). The expression “melt-processable” is herein intended to comprise (A) elastomeric polymers, before the curing step, (B) semi-crystalline polymers and (C) polymers comprising both elastomeric and semi-crystalline segments;
the term “elastomer” is intended to indicate amorphous polymers or polymers having a low degree of crystallinity (crystalline phase less than 20% by volume) and a glass transition temperature value (T_{g}), measured according to ASTM D3418, below room temperature. More preferably, the elastomer according to the present invention has a T_{g} below 10° C., even more preferably below 5° C., as measured as measured according to ASTM D-3418.

Preferably, said polymer (F_{MP}) has a melt viscosity at the processing temperature of no more than 10⁸ Pa×sec, preferably from 10 to 10⁶ Pa×sec. Advantageously, the melt-viscosity of polymer (F_{MP}) can be measured according to ASTM D-1238, using a cylinder, orifice and piston tip made of a corrosion-resistant alloy, charging a sample into the 9.5 mm inside diameter cylinder which is maintained at a temperature exceeding the melting point, extruding the sample through a 2.10 mm diameter, 8.00 mm long square-edged orifice under a load (piston plus weight) of 5 Kg. The melting viscosity (or melt flow index, MFI) is expressed as extrusion rate in grams per minute or alternatively can be calculated in “Pa×sec” from the observable extrusion rate in grams per minute.

Preferably, said polymer (F_{MP}) has a melt flow index comprised between 0.01 and 100 g/10 min, preferably between 0.1 and 80 g/10 min, more preferably between 0.5 and 50 g/10 min, as measured according to ASTM D-1238, using a load of 5 kg and a temperature value selected on the basis of the melting point of the polymer (F_{MP}).

Preferably, said polymer (F_{MP}) has a peak melting temperature (Tₘ) of at most 325° C., preferably of at most 315° C. Preferably, said polymer (F_{MP}) has a peak melting temperature of at least 120° C., preferably of at least 140° C. More preferably, said polymer (F_{MP}) has a peak melting temperature (Tₘ) between 160 and 320° C., more preferably between 180 and 315° C. The melting temperature is determined by Differential Scanning Calorimetry (DSC), at a heating rate of 10° C./min, according to ASTM D-3418.

Preferably, said polymer (F_{MP}) comprises at least one perfluorinated monomer selected in the group comprising, more preferably consisting of:
C₂-C₈ perfluoroolefins, such as tetrafluoroethylene (TFE) and hexafluoropropene (HFP);
CF₂═CFOR_{f1}, wherein R_{f1} is selected from:
(R_{f1}*) C₁-C₆ perfluoroalkyl group, such as —CF₃, —C₂F₅, —C₃F₇; or
(R_{f1}**) —CF₂O(CF₂)ₜOR_{f2}
wherein t is an integer equal to 1 or 2 and R_{f2} is a linear or branched C₁-C₆ perfluoroalkyl group, e.g. —CF₃, —C₂F₅, —C₃F₇; a cyclic C₅-C₆ perfluoroalkyl group, or a linear or branched C₁-C₁₂ (per)fluorooxyalkyl group comprising one or more ether groups, such as —CF₂CF₂OCF₃ and —CF(CF₃)OCF₃;
perfluorodioxoles of formula:

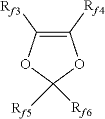

wherein each of R_{f3}, R_{f4}, R_{f5}, R_{f6}, equal of different each other, is independently a fluorine atom, a C₁-C₆ perfluoroalkyl group, optionally comprising one or more oxygen atom, e.g. —CF₃, —C₂F₅, —C₃F₇, —OCF₃, —OCF₂CF₂OCF₃.

According to a first variant, said polymer (F_{MP}) is selected from semi-crystalline perfluoro-polymers [polymer (F_{MP-SC})].

Preferably, said polymer (F_{MP-SC}) is a copolymer of tetrafluoroethylene (TFE), i.e. it comprises recurring units derived from TFE and recurring units derived from at least one perfluorinated monomer different from TFE [co-monomer (F)].

The term “copolymer” is intended to indicate polymers comprising recurring units derived from TFE and recurring units derived from two, three, four or higher, such as up to 10, perfluorinated monomers different from TFE.

More preferably, said at least one co-monomer (F) is selected from the group consisting of:

(i) C₃-C₈ perfluoroolefins, such as hexafluoropropene (HFP);

(ii) CF₂═CFOR_{f1}, wherein R_{f1} is a C₁-C₆ perfluoroalkyl group, such as CF₃, C₂F₅, C₃F₇, a cyclic C₅-C₆ perfluoroalkyl group, or a C₁-C₁₂ (per)fluorooxyalkyl group comprising one or more ether groups, such as —C₂F₅—O—CF₃;

(iii) perfluorodioxoles of formula:

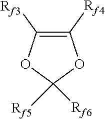

wherein each of R_{f3}, R_{f4}, R_{f5}, R_{f6}, equal of different each other, is independently a fluorine atom, a C₁-C₆ perfluoroalkyl group, optionally comprising one or more oxygen atom, e.g. —CF₃, —C₂F₅, —C₃F₇, —OCF₃, —OCF₂CF₂OCF₃; and

(iv) combinations of (i) to (iii) above.

Even more preferably, said at least one co-monomer (F) is selected in the group consisting of:

(ii) CF₂═CFOR_{f1}, wherein R_{f1} is selected from:
(R_{f1}*) —CF₃, —C₂F₅, and —C₃F₇, namely,
perfluoromethylvinylether (PMVE of formula CF₂═CFOCF₃),
perfluoroethylvinylether (PEVE of formula CF₂═CFOC₂F₅),
perfluoropropylvinylether (PPVE of formula CF₂═CFOC₃F₇), and combinations thereof;
(R_{f1}**) —CF₂OR_{f2},

wherein R_{f2} is a linear or branched C₁-C₆ perfluoroalkyl group, cyclic C₅-C₆ perfluoroalkyl group, a linear or branched C₂-C₆ perfluoroxy-alkyl group; more preferably, R_{f2} is —CF₂CF₃ (MOVE1), —CF₂CF₂OCF₃ (MOVE2), —CF(CF₃)OCF₃ (MOVE2a) or —CF₃ (MOVE3); and combinations thereof.

Preferably, said polymer (F_{MP-SC}) comprises at least 0.6 wt. %, preferably at least 0.8 wt. %, more preferably at least 1 wt. % of recurring units derived from said at least one co-monomer (F).

Preferably, polymer (F_{MP-SC}) comprises at most 70 wt. %, preferably at most 60 wt. %, more preferably at most 40 wt. % of recurring units derived from said at least one co-monomer (F).

In a preferred embodiment of the first variant, said polymer (F_{MP-SC}) is a TFE copolymer consisting essentially of:

(I) from 5 wt. % to 25 wt. % of recurring units derived PMVE; and

(II) recurring units derived from TFE, in such an amount that the sum of the percentages of the recurring units (I) and (II) is equal to 100% by weight.

In another preferred embodiment of the first variant, said polymer (F_{MP-SC}) is a TFE copolymer consisting essentially of:

(I) from 5 wt. % to 25 wt. % of recurring units derived from PMVE;

(II) from 0.5 wt. % to 5 wt. % of recurring units derived from PPVE; and

(III) recurring units derived from TFE, in such an amount that the sum of the percentages of the recurring units (I), (II) and (III) is equal to 100% by weight.

In still another preferred embodiment of the first variant, said polymer (F_{MP-SC}) is a TFE copolymer consisting essentially of:

(I) from 1 wt. % to 25 wt. % of recurring units derived PPVE; and

(II) recurring units derived from TFE, in such an amount that the sum of the percentages of the recurring units (I) and (II) is equal to 100% by weight.

Suitable polymers (F_{MP-SC}) for the present invention are commercially available from Solvay Specialty Polymers Italy S.p.A. under the trade name of HYFLON®.

According to a second variant, said polymer (F_{MP}) is a perfluoro-elastomer [polymer (F_{MP-PFE})], which comprises recurring units derived from the perfluorinated monomers cited above and, optionally, one or more cure sites, either as pendant groups bonded to certain recurring units or as ends groups of the polymer chain.

According to this second variant, polymer (F_{MP-PFE}) is preferably selected from those having the following compositions (wherein the amounts are expressed in mol %):

(i) tetrafluoroethylene (TFE) 50-80%, perfluoroalkyl vinyl ethers (PAVE) 20-50%, bis-olefin (OF) 0-5%;

(ii) tetrafluoroethylene (TFE) 20-70%, fluorovinyl ethers (MOVE) 30-80%, perfluoroalkyl vinyl ethers (PAVE) 0-50%, bis-olefin (OF) 0-5%.

Suitable examples of polymers (F_{MP-PFE}) are the products sold by SOLVAY SPECIALTY POLYMERS S.p.A. under the trade name Tecnoflon® PFR Grades.

According to a third variant, said polymer (F_{MP}) is a perfluorinated thermoplastic elastomer [polymer (F_{MP-TPE})] comprising:
at least one elastomeric block (A) consisting of a sequence of recurring units derived from tetrafluoroethylene (TFE) and recurring units derived from at least one perfluorinated monomer other than TFE, and possibly of a minor amount of recurring units derived from at least one bis-olefin [bis-olefin (OF)] of formula R_{A}R_{B}═CR_{C}-T-CR_{D}═R_{E}R_{F},

wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, preferably at least partially fluorinated, or a (per)fluoropolyoxyalkylene group,

wherein the molar percentage of recurring units derived from TFE in said block (A) is comprised between 40 and 82% moles, with respect to the total moles of recurring units of the said block (A), and wherein said block (A) possesses a glass transition temperature of less than 25° C., as determined according to ASTM D3418, and
at least one thermoplastic block (B) consisting of a sequence of recurring units derived from tetrafluoroethylene (TFE) and recurring units derived from at least one perfluorinated monomer other than TFE,

wherein the molar percentage of recurring units derived from TFE in said block (B) is comprised between 85 and 98% moles, and wherein the crystallinity of said block (B) and its weight fraction in the polymer (pF-TPE) are such to provide for a heat of fusion of the polymer (pF-TPE) of at least 2.5 J/g, when determined according to ASTM D3418.

For the purpose of the present invention, the term “elastomeric”, when used in connection with the “block (A)” is hereby intended to denote a polymer chain segment which, when taken alone, is substantially amorphous, that is to say, has a heat of fusion of less than 2.0 J/g, preferably of less than 1.5 J/g, more preferably of less than 1.0 J/g, as measured according to ASTM D3418.

For the purpose of the present invention, the term “thermoplastic”, when used in connection with the “block (B)”, is hereby intended to denote a polymer chain segment which, when taken alone, is semi-crystalline, and possesses a detectable melting point, with an associated heat of fusion of exceeding 10.0 J/g, as measured according to ASTM D3418.

Said polymer (F_{MP-TPE}) can be referred to as a block copolymer, said block copolymer typically having a structure comprising at least one block (A) alternated to at least one block (B), that is to say that said polymer (F_{MP-TPE}) typically comprises, preferably consists of, one or more than one repeating structures of type (B)-(A)-(B). Generally, polymer (F_{MP-TPE}) has a structure of type (B)-(A)-(B), i.e. comprising a central block (A) having two ends, connected at both ends to a side block (B).

The said perfluorinated monomer other than TFE is advantageously selected from the group provided above for the co-monomer (F).

Preferably, the bis-olefin (OF), cited within the present description for the second and the third variant of the invention, is selected from the group consisting of those of any of formulae (OF-1), (OF-2) and (OF-3):

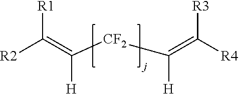

wherein j is an integer comprised between 2 and 10, preferably between 4 and 8, and R1, R2, R3 and R4, equal to or different from each other, are selected from the group consisting of H, F, C₁-C₅ alkyl groups and C₁-C₅ (per)fluoroalkyl groups;

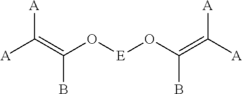

wherein each of A, equal to or different from each other and at each occurrence, is independently selected from the group consisting of H, F and Cl; each of B, equal to or different from each other and at each occurrence, is independently selected from the group consisting of H, F, Cl and OR_{B}, wherein R_{B} is a branched or straight chain alkyl group which may be partially, substantially or completely fluorinated or chlorinated, E is a divalent group having 2 to 10 carbon atoms, optionally fluorinated, which may be inserted with ether linkages; preferably E is a —(CF₂)ₘ— group, wherein m is an integer comprised between 3 and 5; a preferred bis-olefin of (OF-2) type is F₂C═CF—O—(CF₂)₅—O—CF═CF₂;

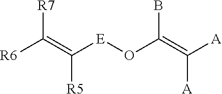

wherein E, A and B have the same meaning as defined above, R5, R6 and R7, equal to or different from each other, are selected from the group consisting of H, F, C₁-C₅ alkyl groups and C₁-C₅ (per)fluoroalkyl groups.

The elastomeric block (A) preferably consists of a sequence of:
recurring units derived from tetrafluoroethylene (TFE) in an amount of 40 to 82% moles, preferably from 50 to 75% moles, and most preferably from 54 to 70% moles;
recurring units derived from at least one perfluorinated monomer other than TFE, as above detailed, in an amount of 18 to 55% moles, preferably from 25 to 48% moles, and most preferably from 30 to 45% moles; and
possibly, recurring units derived from a bis-olefin (OF), as above detailed, in an amount of 0 to 5% moles, preferably of 0 to 2% moles, more preferably of 0 to 1% moles,

with respect to the total moles of recurring units of block (A)

The elastomeric block (A) possesses a glass transition temperature of less than 25° C., preferably of less than 20° C., more preferably of less than 15° C., as determined according to ASTM D3418.

The thermoplastic block (B) preferably consists of a sequence of:
recurring units derived from tetrafluoroethylene (TFE) in an amount of 85 to 99.5% moles, preferably from 88 to 97% moles, and most preferably from 90 to 96% moles;
recurring units derived from at least one perfluorinated monomer other than TFE, as above detailed, in an amount of 0.5 to 15% moles, preferably from 3 to 12% moles, and most preferably from 4 to 10% moles,

with respect to the total moles of recurring units of block (B).

The weight ratio between blocks (A) and blocks (B) in said polymer (F_{MP-TPE}) is typically comprised between 95:5 and 10:90.

Said polymer (F_{MP-TPE}) can be advantageously prepared by a method comprising the following sequential steps:

(a) polymerizing TFE, at least one perfluorinated monomer other than TFE, and possibly at least one bis-olefin (OF), in the presence of a radical initiator and of an iodinated chain transfer agent, thereby providing a pre-polymer consisting of at least one block (A) containing one or more iodinated end groups; and

(b) polymerizing TFE, at least one perfluorinated monomer other than TFE, in the presence of a radical initiator and of the pre-polymer provided in step (a), thereby providing at least one block (B) grafted on said pre-polymer through reaction of the said iodinated end groups of the block (A).

The method of the invention is preferably carried out in aqueous emulsion polymerization according to methods well known in the art, in the presence of a suitable radical initiator.

The radical initiator is typically selected from the group consisting of:
inorganic peroxides such as, for instance, alkali metal or ammonium persulphates, perphosphates, perborates or percarbonates, optionally in combination with ferrous, cuprous or silver salts or other easily oxidable metals;
organic peroxides such as, for instance, disuccinylperoxide, tertbutyl-hydroperoxide, and ditertbutylperoxide; and
azo compounds (see, for instance, U.S. Pat. No. 2,515,628 (E.I. DU PONT DE NEMOUS AND CO.) and U.S. Pat. No. 2,520,338 (E.I. DU PONT DE NEMOURS AND CO.).

When step (a) is terminated, the reaction is discontinued, for instance by cooling, and the residual monomers are removed, for instance by heating the emulsion under stirring.

The second polymerization step (b) is then carried out, feeding the new monomer mixture and adding fresh radical initiator.

If necessary, under step (b) of the process for the manufacture of the polymer (F_{MP-TPE}), one or more further chain transfer agents may be added, which can be selected from the same iodinated chain transfer agents as defined above or from chain transfer agents known in the art for use in the manufacture of fluoropolymers such as, for instance, ketones, esters or aliphatic alcohols having from 3 to 10 carbon atoms, such as acetone, ethylacetate, diethylmalonate, diethylether and isopropyl alcohol; hydrocarbons, such as methane, ethane and butane; chloro(fluoro)carbons, optionally containing hydrogen atoms, such as chloroform and trichlorofluoromethane; bis(alkyl)carbonates wherein the alkyl group has from 1 to 5 carbon atoms, such as bis(ethyl) carbonate and bis(isobutyl) carbonate.

When step (b) is completed, polymer (F_{MP-TPE}) is generally isolated from the emulsion according to conventional methods, such as by coagulation by addition of electrolytes or by cooling.

Alternatively, the polymerization reaction can be carried out in mass or in suspension, in an organic liquid where a suitable radical initiator is present, according to known techniques. The polymerization temperature and pressure can vary within wide ranges depending on the type of monomers used and based on the other reaction conditions.

Advantageously, said molecule grafted onto said surface (S) is selected from the group comprising molecules containing at least one bond between nitrogen atom and an element belonging to Group 14 of the Periodic Table, even more preferably carbon or silicon. Thus, the molecule grafted onto said surface (S) preferably comprises at least one bond —C—N— or —Si—N—.

Advantageously, said molecule is selected from the group comprising silazanes, aziridines, azides, anilines, pyrrole, pyridines, imines, nitriles, amines and amides. More preferably, said molecule is selected from the group comprising, even more preferably consisting of: allylamine, hexadimethylsilazane (HMDSN), pyrrolidine, pyrrole, acetonitrile, aniline.

Preferably, said compound (M) comprises at least one metal selected from the group consisting of: Rh, Ir, Ru, Ti, Re, Os, Cd, Tl, Pb, Bi, In, Sb, Al, Ti, Cu, Ni, Pd, V, Fe, Cr, Mn, Co, Zn, Mo, W, Ag, Au, Pt, Ir, Ru, Pd, Sn, Ge, Ga and alloys thereof.

More preferably, said compound (M) comprises at least one metal selected from the group consisting of Ni, Cu, Pd, Co, Ag, Au, Pt, Sn and alloys thereof. Even more preferably, said compound (M) comprises Cu, Ni and Pd.

The thickness of said layer (L1) is not particularly limited. For example, said layer (L1) has a thickness of from 1 nm to 10 μm, more preferably of from 10 nm to 1 μm.

Preferably, said layer (L1) is a continuous layer, i.e., it completely covers said surface (S). However, depending on the application, said layer (L1) can be a discontinuous layer, partially covering said surface (S), i.e. said surface (S) comprises at least one area that is not covered by said layer (L1).

Advantageously, said compound (G) is selected from the group comprising molecules containing at least one nitrogen atom, at least one carbon atom and at least one bond between said nitrogen atom and an element belonging to Group 14 of the Periodic Table, even more preferably carbon or silicon. According to a preferred embodiment, said compound (G) comprises at least one bond —C—N— or —Si—N—.

Advantageously, said compound (G) is selected from the group comprising silazanes, aziridines, azides, anilines, pyrrole, pyridines, imines, nitriles, amines and amides. More preferably, said compound (G) is selected from the group comprising, even more preferably consisting of: allylamine, hexadimethylsilazane (HMDSN), pyrrolidine, pyrrole, acetonitrile, aniline.

Preferably, said step (ii) is performed in the presence of a nitrogen-containing gas.

According to a preferred embodiment, said nitrogen-containing gas is selected from N₂, NH₃ or mixtures thereof, optionally in admixture with nitrogen-free gas such as CO₂ and/or H₂. Good results have been obtained by using N₂.

The gas rate can be selected by the skilled person. Preferably, the gas rate was between 10 nl/min and 30 nl/min.

Preferably, said step (iii) is performed by an atmospheric plasma process.

Preferably, said atmospheric plasma process is performed under atmospheric pressure and with an equivalent corona dose of from 50 Wmin/m² to 30,000 Wmin/m², more preferably of from 500 Wmin/m² to 15000 Wmin/m².

Preferably, under step (iii) of the present invention, said composition (C1) is in the form of solution in a suitable solvent, such as water.

Preferably, step (iii) is performed by contacting the surface of the article as obtained in step (ii) with said composition (C1).

Preferably, compounds that may be employed as metallization catalysts in the method of the present invention can be provided in the form of metal, ion or complex thereof.

More preferably, in the process of the present invention, the metallization catalyst is provided in the form of ion. According to this embodiment, the method according to the present invention comprises after step (iii) and before step (iv), a step (iii-b) of reducing the metallization catalyst in the form of ion to metal.

Preferably, said metallization catalyst is selected in the group comprising Pd, Pt, Rh, Ir, Ni, Cu, Ag and Au catalysts.

More preferably, the metallization catalyst is selected from Pd catalysts, such as PdCl₂.

Preferably, under step (iv), said composition (C2) is an electroless metallization plating bath, comprising at least one compound (M1), at least one reducing agent, at least one liquid medium and, optionally, one or more additives.

Preferably, said compound (M1) comprises one or more metal salts. More preferably, said compound (M1) preferably comprises one or more metal salts of the metals listed above with respect to compound (M).

Preferably, said reducing agent is selected from the group comprising formaldehyde, sodium hypophosphite, hydrazine, glycolic acid and glyoxylic acid.

Preferably, said liquid medium is selected from the group comprising water, organic solvents and ionic liquids.

Among organic solvents, alcohols are preferred such as ethanol.

Non-limitative examples of suitable ionic liquids include, notably, those comprising as cation a sulfonium ion or an imidazolium, pyridinium, pyrrolidinium or piperidinium ring, said ring being optionally substituted on the nitrogen atom, in particular by one or more alkyl groups with 1 to 8 carbon atoms, and on the carbon atoms, in particular by one or more alkyl groups with 1 to 30 carbon atoms.

Preferably, the ionic liquid is advantageously selected from those comprising as anion those chosen from halides anions, perfluorinated anions and borates.

Preferably, additives are selected from the group comprising salts, buffers and other materials suitable for enhancing stability of the catalyst in the liquid composition.

Preferably, said step (iv) is performed at a temperature above 40° C., more preferably between 50° C. and 120° C.

Advantageously, according to an embodiment, step (iv) is performed so as to provide a continuous layer [layer (L)] comprising compound M onto said surface (S3), i.e. a layer that completely covers said surface (S3).

Embodiments wherein said layer comprising compound M covers only certain areas of said surface (S3) are also encompasses by the present invention.

The thickness of the layer comprising compound M is not particularly limited. For example, said layer has a thickness of from 0.1 nm to 10 μm, preferably from 10 nm to 1 μm.

Preferably, said steps (iii) and (iv) are performed as a single step [step (iii-D)], more preferably by electroless deposition.

By “electroless deposition” it is meant a redox process typically carried out in a plating bath between a metal cation and a proper chemical reducing agent suitable for reducing said metal cation in its elemental state.

The preferred conditions disclosed above with respect to step (iii) and step (iv) apply whether step (iii) and step (iv) are performed separately or when step (iii) and step (iv) are performed as a single step (iii-D).

Optionally, the above method comprises after step (iv), step (v) of applying a composition [composition (C3)] containing at least one metal compound [compound (M2)] onto said surface (S), so as to provide an external surface [surface (Sₑ)] comprising at least two compounds (M).

Preferably, said composition (C3) is an electrolytic solution, comprising at least one compound (M2), at least one metal halide and, optionally, at least one ionic liquid as defined above.

Said compound (M2) can be the same or different from said compound (M1).

Preferably, said compound (M2) is a metal salt deriving from Al, Ni, Cu, Ag, Au, Cr, Co, Sn, Ir, Pt and alloys thereof.

Preferably, said metal halide is PdCl₂.

Preferably, said step (v) is performed by electro-deposition.

Within the present description and in the following claims, by “electro-deposition” it is meant a process using electrical current to reduce metal cations from an electrolytic solution.

Should the disclosure of any patents, patent applications, and publications which are incorporated herein by reference conflict with the description of the present application to the extent that it may render a term unclear, the present description shall take precedence.

Experimental Section

Materials:

HYFLON® P450 perfluoropolymer (herein after referred to as polymer P1) and HYFLON® P420 perfluoropolymer (herein after referred to as polymer P2) were obtained from Solvay Specialty Polymers Italy S.p.A. Allylamine, hexadimethylsilazane (HMDSN), pyrrole and acetonitrile were obtained by Sigma-Aldrich.

### EXAMPLE 1

### Manufacture of a Multi-Layered Sample

From each polymer P1 and P2, plaques measuring 10×10 cm and 150 μm thick were obtained.

Step a. The surface of each plaque was treated at atmospheric pressure by a radio-frequency plasma discharge process, using Plasmatreater® AS400 instrument, in the following conditions:

etching gas: N₂,

working frequency: 20 kHz

voltage: 0.3 kV.

During the treatment, each of the precursors listed in Table 1 below was deposited onto the surface of one plaque, after being vaporized and inputted into the plasma chamber.

Water contact angles of the samples thus obtained were measured. The measured values are reported in the following Table 1.

As comparison, a plaque obtained from the same polymers P1 and P2, was treated following the same procedure describe din step (a), but without addition of the precursors. This comparison example was representative of the procedure known in the art for the treatment of partially fluorinated polymers.

TABLE 1

| | Polymer used for | | |
|---|---|---|---|
| | making the | | Water contact |
| Plaque | Plaque | Treatment | angle |
| 1(*) | P1 | pristine surface | 102° |
| 2(*) | P1 | Step (a) without precursor | 101° |
| 3 | P1 | Step (a) + allylamine | 22.9° |
| 4 | P1 | Step (a) + HMDSN | 18.8° |
| 5 | P1 | Step (a) + pyrrole | 24.6° |
| 6 | P1 | Step (a) + acetonitrile | 41.8° |

(*)comparison

The above results demonstrated that the treatment according to the prior art with nitrogen gas only, was not effective on perfluoropolymers. On the contrary, all the precursors provided a reduction of water contact angle and thus an increment of surface reactivity.

Step b. The surface of each Plaque, obtained after step (a) above, was coated with metallic nickel by electroless plating. First, the treated surface of the sample was activated by immersion in an aqueous solution containing 0.03 g/L of PdCl₂ for 3 minute (pH=9.5), resulting in the treated surface of the sample being entirely coated with Pd particles at a high density. The so activated surface was then immersed in an aqueous plating bath containing 10 g/L of NiSO₄, 8 g/L NaPO₂H₂ and organic additives. The plating temperature was 90° C. and its pH value was 5.

The thickness of the nickel layer coated onto the treated surface was 0.2 μm as measured by SEM.

### EXAMPLE 2

### Evaluation of Adhesion of the Metallic Layer

The adhesion of the metallic layer was evaluated on the metallic layer obtained on Plaques 5 to 12 obtained according to the invention and on the comparison Plaque 2(*), obtained as disclosed above.

The adhesion was evaluated as follows: using a cutting tool, two series of perpendicular cuts were performed on the metallic layer of each Plaque 5 to 12 and 3(*), in order to create a lattice pattern on them. A piece of tape was then applied and smoothened over the lattice and removed with an angle of 180° with respect to the metallic layer.

The adhesion of metallic layer was then assessed by comparing the lattice of cuts with the ASTM D3359 standard procedure. The classification of test results ranged from 5B to 0B, whose descriptions are depicted in Table 2 herein below.

TABLE 2

| ASTM D3359 | |
|---|---|
| Classification | Description |
| 5B | The edges of the cuts are completely |
| | smooth; none of the squares of the lattice is |
| | detached. |
| 4B | Detachment of flakes of the coating at the |
| | intersections of the cuts. A cross cut area |
| | not significantly greater than 5% is affected. |
| 3B | The coating has flaked along the edges |
| | and/or at the intersection of the cuts. A |
| | cross cut area significantly greater than 5%, |
| | but not significantly greater than 15% is |
| | affected. |
| 2B | The coating has flaked along the edges of |
| | the cuts partly or wholly in large ribbons, |
| | and/or it has flaked partly of wholly on |
| | different parts of the squares. A cross cut |
| | area significantly greater than 15%, but not |
| | significantly greater than 65%, is affected. |
| 1B | The coating has flaked along the edges of |
| | the cuts in large ribbons and/or some |
| | squares have detached partly or wholly. A |
| | cross cut area significantly greater than |
| | 35%, but not significantly greater than 65%, |
| | is affected. |
| 0B | Any degree of flaking that cannot be |
| | classified even by classification 1B. |

The adhesion values obtained for the samples were as follows:
each of Plaque 5 to 12=5B;
Plaque 3(*)=0B.

The above results demonstrated the excellent adhesion achieved on the article made of perfluoropolymer according to the process of the present invention.

Another Plaque according to the invention was subjected to thermal ageing by treatment at 250° C. for 100 hours. At the end of the thermal treatment, the surface of the sample comprising the metallic layer was cross-cut and the adhesion was evaluated as following the same classification from 0B to 5B.

The adhesion value obtained for the sample after thermal treatment was 5B.

1. A multi-layered article made of a composition (C), wherein composition (C) comprises at least one melt-processable fully fluorinated polymer (F_{MP}), said article having at least one surface (S) comprising:
at least one molecule grafted onto said surface (S), said molecule comprising at least one nitrogen atom and at least one carbon atom, and
at least one layer (L1) adhered to said surface (S) comprising at least one metal compound (M).

2. The multi-layered article according to claim 1, wherein said polymer (F_{MP}) comprises at least one perfluorinated monomer selected from the group consisting of:
C₂-C₈ perfluoroolefins;
CF₂═CFOR_{f1}, wherein R_{f1} is selected from:
(R_{f1}*) C₁-C₆ perfluoroalkyl group; or
(R_{f1}**) —CF₂O(CF₂)ₜOR_{f2}
wherein t is an integer equal to 1 or 2 and R_{f2} is a linear or branched C₁-C₆ perfluoroalkyl group; a cyclic C₅-C₆ perfluoroalkyl group, or a linear or branched C₁-C₁₂ (per)fluorooxyalkyl group comprising one or more ether groups;
perfluorodioxoles of formula: 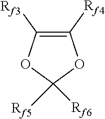
wherein each of R_{f3}, R_{f4}, R_{f5}, R_{f6}, equal of different each other, is independently a fluorine atom or a C₁-C₆ perfluoroalkyl group, optionally comprising one or more oxygen atom.

3. The multi-layered article according to claim 1, wherein said polymer (F_{MP}) is selected from group consisting of semi-crystalline perfluoro-polymers (F_{MP-SC}), perfluoro-elastomers [polymer (F_{MP-PFE})] and perfluorinated thermoplastic elastomers [polymer (F_{MP-TPE})].

4. The multi-layered article according to claim 3, wherein said polymer (F_{MP-SC}) comprises recurring units derived from TFE and recurring units derived from at least one comonomer (F), wherein comonomer (F) is at least one perfluorinated monomer different from TFE.

5. The multi-layered article according to claim 4, wherein said at least one co-monomer (F) is selected from the group consisting of:
(i) C₃-C₈ perfluoroolefins;
(ii) CF₂═CFOR_{f1}, wherein R_{f1} is a C₁-C₆ perfluoroalkyl group, a cyclic C₅-C₆ perfluoroalkyl group, or a C₁-C₁₂ (per)fluorooxyalkyl group comprising one or more ether groups;
(iii) perfluorodioxoles of formula: 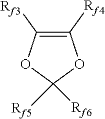
wherein each of R_{f3}, R_{f4}, R_{f5}, R_{f6}, equal of different each other, is independently a fluorine atom or a C₁-C₆ perfluoroalkyl group, optionally comprising one or more oxygen atom; and
(iv) combinations of (i) to (iii) above.

6. The multi-layered article according to claim 3, wherein:
(A) said polymer (F_{MP-PFE}) is selected from those having the following compositions (wherein the amounts are expressed in mol %):
(i) tetrafluoroethylene (TFE) 50-80%, perfluoroalkyl vinyl ethers (PAVE) 20-50%, bis-olefin (OF) 0-5%;
(ii) tetrafluoroethylene (TFE) 20-70%, fluorovinyl ethers (MOVE) 30-80%, perfluoroalkyl vinyl ethers (PAVE) 0-50%, bis-olefin (OF) 0-5%; and
(B) said polymer (F_{MP-TPE}) comprises:
at least one elastomeric block (A) consisting of a sequence of recurring units derived from tetrafluoroethylene (TFE) and recurring units derived from at least one perfluorinated monomer other than TFE, and optionally of a minor amount of recurring units derived from at least one bis-olefin (OF) of formula R_{A}R_{B}═CR_{C}-T-CR_{D}═R_{E}R_{F},
wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, optionally at least partially fluorinated, or a (per)fluoropolyoxyalkylene group,
wherein the molar percentage of recurring units derived from TFE in said block (A) is comprised between 40 and 82% moles, with respect to the total moles of recurring units of the said block (A), and
wherein said block (A) possesses a glass transition temperature of less than 25° C., as determined according to ASTM D3418, and
at least one thermoplastic block (B) consisting of a sequence of recurring units derived from tetrafluoroethylene (TFE) and recurring units derived from at least one perfluorinated monomer other than TFE,
wherein the molar percentage of recurring units derived from TFE in said block (B) is comprised between 85 and 98% moles, and
wherein the crystallinity of said block (B) and its weight fraction in the polymer (pF-TPE) are such to provide for a heat of fusion of the polymer (pF-TPE) of at least 2.5 J/g, when determined according to ASTM D3418.

7. The multi-layered article according to claim 1, wherein said molecule grafted onto said surface (S) is selected from the group consisting of molecules containing at least one bond between nitrogen atom and an element belonging to Group 14 of the Periodic Table.

8. The multi-layered article according to claim 7, wherein said molecule is selected from the group consisting of silazanes, aziridines, azides, anilines, pyrrole, pyridines, imines, nitriles, amines and amides.

9. The multi-layered article according to claim 1, wherein said compound (M) comprises at least one metal selected from the group consisting of: Rh, Ir, Ru, Ti, Re, Os, Cd, Tl, Pb, Bi, In, Sb, Al, Ti, Cu, Ni, Pd, V, Fe, Cr, Mn, Co, Zn, Mo, W, Ag, Au, Pt, Ir, Ru, Pd, Sn, Ge, Ga and alloys thereof.

10. A method for manufacturing a multi-layered article as defined in claim 1, said method comprising:
(i) providing an article made from a composition (C) comprising at least one melt-processable fully fluorinated polymer (F_{MP}), said article having at least one surface (S-1);
(ii) contacting said surface (S-1) with a gaseous compound (G) comprising at least one nitrogen atom and at least one carbon atom, to provide an article having at least one surface (S−2);
(iii) contacting said at least one surface (S-2) with a first composition (C1) comprising at least one metallization catalyst, so as to provide an article having at least one surface (S-3) containing at least one nitrogen atom bonded to said at least one metallization catalyst; and
(iv) contacting said at least one surface (S-3) with a second composition (C2) containing at least one metal compound (M1), so as to provide a multi-layered article having at least one surface (S) comprising nitrogen-containing groups and at least one layer (L1) adhered to said surface (S) comprising at least one metal compound (M),
wherein said step (ii) is performed at atmospheric pressure.

11. The method according to claim 10, said method comprising after said step (iv), step (v) of applying a third composition (C3) containing at least one metal compound (M2) onto said surface (S).

12. The method according to claim 10, wherein said compound (G) is selected from the group consisting of molecules containing at least one nitrogen atom, at least one carbon atom and at least one bond between said nitrogen atom and an element belonging to Group 14 of the Periodic Table.

13. The method according to claim 10, wherein said step (ii) is performed in the presence of a nitrogen-containing gas.

14. The method according to claim 10, wherein said step (iii) is performed by an atmospheric plasma process.

15. The method according to claim 10, wherein said steps (iii) and (iv) are performed as a single step (iii-D).

16. The method according to claim 11, wherein step (v) is performed by electro-deposition.

17. The multi-layered article according to claim 5, wherein R_{f1} is —CF₃, —C₂F₅, —C₃F₇, or —C₂F₅—O—CF₃.

18. The multi-layered article according to claim 7, wherein said molecule grafted onto said surface (S) is selected from the group consisting of molecules containing at least one bond between nitrogen atom and carbon or silicon.
